(19) United States
(12) Patent Application Publication
(10) Pub. No.: US 2011/0307210 A1
(43) Pub. Date: Dec. 15, 2011

(54) SYSTEM AND METHOD FOR TRACKING A MOBILE NODE

(75) Inventors: Mark B. Stevens, Austin, TX (US); John D. Wilson, Houston, TX (US)

(73) Assignee: INTERNATIONAL BUSINESS MACHINES CORPORATION, Armonk, NY (US)

(21) Appl. No.: 12/814,893

(22) Filed: Jun. 14, 2010

(51) Int. Cl. G06F 15/00

(52) U.S. Cl. 702/150

(57) ABSTRACT

Techniques for tracking the position and movement of a mobile node within a field of fixed nodes are disclosed herein. In one embodiment, positional information generated from neighboring nodes in the field of nodes along with positional information obtained from the mobile node itself is compiled and used to track the location of the mobile node. The field of fixed nodes may relay positional information to interested nodes within the field in order to communicate the movement of the mobile node. Based on the positional information of the mobile node, the mobile node can be tracked, and an estimated time of arrival and a likelihood of reaching a defined point or a fixed node can be computed. Additionally, fixed nodes may use the estimated time of arrival and likelihood calculations to initiate anticipatory processing if the mobile node is likely to encounter the fixed node.

### FIELD OF THE INVENTION

The present invention generally relates to the movement and interaction of nodes, agents, and other devices and objects within intelligent systems and networks. The present invention more specifically relates to movement prediction and tracking for mobile or roving objects in a real-world scenario with a plurality of independent, intelligent actors.

### BACKGROUND OF THE INVENTION

In a “smart world,” there is a distributed collection of devices, sensors, embedded systems, processors and other information sources. Many of these are generally fixed in place (referred to herein as fixed nodes) and are intended in some way to interact with other intelligent elements that pass through this field of fixed intelligent nodes (these movable nodes being referred to herein as “mobile nodes” or “rover nodes”).

The interaction between fixed nodes and mobile nodes is finite and may be short lived. In order for the fixed node to be able to perform useful work with the mobile node, it may be very important that the fixed node be forewarned of the arrival of the mobile node so that anticipatory processing or data access may be performed prior to the mobile node's arrival. This enables the useful work between the mobile node and the fixed node to take place during the brief interaction period as the mobile node passes into and then out of the fixed node's area of operation.

Various techniques and systems in the prior art provide the capability of tracking and monitoring a moving object via radar or RF tag detection. Another known movement tracking technique involves an arrangement of three or more sensors to measure the speed of a moving object. Another technique uses embedded sensors to detect movement along a predetermined path. And other techniques use video surveillance with some differential processing to determine location, movement, and direction.

With the exception of using radar, all of these techniques suffer the drawback of losing track of the moving object once it is outside the field of view or sensing. Using radar to track moving objects throughout an ecosystem of distributed intelligent nodes is massive overkill from the support of the infrastructure, costs, complexity, and electronic pollution. What is needed are enhanced techniques and systems for tracking the location and path of a moving node.

### BRIEF SUMMARY OF THE INVENTION

The present disclosure describes various techniques that allow a fixed node to anticipate and respond to the arrival or projected arrival of mobile nodes into its locale. This may include cases when the movement intentions of the mobile node are not known to its surrounding field of nodes or when the mobile node has previously communicated its path intentions. Based on calculations of the expected arrival and path of the mobile node, certain actions may be taken at the fixed node. For example, the fixed node may perform pre-processing in response to a close proximity of the node or prepare for an upcoming encounter between the mobile node and the fixed node. Additionally, based on information derived from the mobile node's movement, the fixed node may perform various activities that attempt to induce the mobile node to perform some behavior (such as changing the mobile node's path to cause the mobile node to encounter or avoid the fixed node).

One embodiment of the presently described invention provides a system and method that allows a fixed node to anticipate the arrival of mobile nodes into the locale of a fixed node when the movement intentions of the mobile node are not known to a field of fixed nodes. A cooperative technique may be used to track the mobile node within the field of nodes to determine if and when the mobile node may arrive at or be proximate to one of the fixed nodes. The field of fixed nodes communicates with each other to relay movement information about the mobile node, allowing a full view of the mobile node's movement without requiring dedicated sensing nodes.

In a further embodiment of the presently described invention, the mobile node communicates its path intentions prior to or during its navigation of the path. A similar cooperative technique is used to track the mobile node within a field of fixed nodes to communicate and determine if and when the mobile node may arrive at one of the fixed nodes. This may also include verifying the node's movement against the path intentions, and/or estimating process of the node's movement against the path intentions.

The presently described field of fixed nodes may operate to gather information about mobile nodes in a way that mirrors the real-world. Real-world objects do not move in a simple way, but rather interact in a chaotic way. Therefore, the various embodiments described herein enable more than just predicting distance or an estimated time of arrival, but enable a field of fixed nodes to track and respond to the exact movement of mobile nodes.

In one specific embodiment described herein, a method for tracking a mobile node in a field of nodes includes collecting and processing location data of the mobile node. In this specific embodiment, a selected node (such as a fixed node) obtains positional data indicating a geographic location of the mobile node. This positional data may include location measurements conducted by other nodes in the field of nodes, or may be relayed throughout the field of nodes through a variety of peer-to-peer communication techniques. The format of the positional data may include an identifier of the mobile node, latitude and longitude coordinates, and a time of positional measurement. In further embodiments, location data may be directly provided from communications or sensing with the mobile device.

Historical positional data of the mobile node is then collected or received, with this historical positional data including a plurality of geographical locations of the mobile node within the field of nodes over a period of time. Based upon the historical positional data, a geographic path and movement characteristics of the mobile node may be computed. Further, future geographic locations of the mobile node may be predicted. In further embodiments, the mobile node communicates its intended path, such as its intended start and end path locations, and/or its path status. Such path information may also be factored with these historical computations.

Based on the tracking data obtained and the path predictions for the mobile node, a sufficient amount of data may be used to estimate the time of arrival and a likelihood of arrival of the mobile node. This data may be used to more closely isolate data and predictions to a defined proximity of the selected node, and certain periods of future time.

Once a sufficient level of confidence is computed for the speed and direction of the mobile node's movement, appropriate actions may be initiated by the selected node or other nodes in the field of nodes. For example, anticipatory and preparatory processing may occur at the selected node prior to the estimated arrival of the mobile node. Further, configuration parameters relevant to the mobile node may be used to affect tracking of the mobile nodes or processing actions relevant to the mobile nodes.

Another specific embodiment of the present invention includes a system used for tracking a mobile node, including a field of nodes, a communications network between the plurality of nodes within the field, and processing instructions executed on hardware within the plurality of nodes to implement the various techniques described herein. Yet another specific embodiment of the present invention includes a computer program product for tracking a mobile node, the computer program product comprising a computer readable storage medium having computer readable program code embodied therewith to implement the various techniques described herein.

### BRIEF DESCRIPTION OF THE DRAWINGS

FIG. 1 provides an illustration of a mobile node navigating though a field of fixed nodes, the fixed nodes adapted to track and predict the path of the mobile node's navigation in accordance with one embodiment of the present invention;

FIG. 2 provides a flowchart demonstrating a technique for tracking and predicting the path of a mobile node in accordance with one embodiment of the present invention; and

FIG. 3 provides a flowchart demonstrating a technique for tracking a mobile node that is moving on a defined path in accordance with one embodiment of the present invention.

### DETAILED DESCRIPTION OF THE INVENTION

One aspect of the present invention includes the use of cooperative techniques to track a moving intelligent object (referred to herein as a “mobile” or “roving” node) within a field of fixed, generally stationary nodes. These techniques enable the fixed nodes to determine if and when the mobile node may arrive at or near one of the fixed nodes. Based on derived information concerning the mobile node's path, speed, time of arrival, and other movement characteristics, specific processing may be performed by the fixed nodes. This may include anticipatory processing in advance of the arrival of the node, or other special processing that occurs responsive to the proximity of the mobile node to the fixed node.

In one embodiment, a plurality of fixed nodes monitor the location of the mobile node as the mobile node passes by each fixed node's locale. The fixed nodes may detect the presence of the mobile node through any one of a number of locating mechanisms known in the art, or simply by communicating with the mobile node as it passes through the fixed nodes' very local network. Additionally, other calculations and estimations may be performed by the fixed node in order to secure the precise movement and location of the mobile node.

In another embodiment, the mobile node publishes its movement path or schedule in advance or at regular intervals. This allows the fixed nodes to cooperate and verify the schedule as the mobile node actually moves through the field of fixed node. If the mobile node will not publish or share its schedule, the detection of the mobile node location will fall solely to the nodes in the field of fixed nodes that the mobile node is navigating through. In such a case where the mobile node does not provide its schedule, the fixed nodes cooperate by using the previously described detection and communication methods.

Some of the advantages as compared with existing methods in the art are that the techniques disclosed herein enable tracking the exact movement of nodes without an expensive or complex sensing system. The presently disclosed techniques also enable all of the nodes in the field, and not just a sensing node, to be aware of the progress of a mobile node. Therefore, tracking of the mobile node is not harmed in cases where a particular sensing node misses the mobile node, or if the sensing node does not provide fully accurate data. Additionally, the presently disclosed techniques provide any fixed node with the ability to develop and process a list of potentially relevant mobile nodes that may come into its locale at some point in the near future.

As described herein, a node may be any device or “thinking” being, such as a computing device, electronic processing unit, sensor, or other object that is capable of detecting and processing movement of other nearby objects. In other words, this may be any smart processing device that is aware of its environment, even if it is only aware of a small area proximate to itself. With the proliferation of computers, portable electronic devices, and sensors throughout real-world environments, many such devices may be adapted to provide useful data on the movement of mobile nodes.

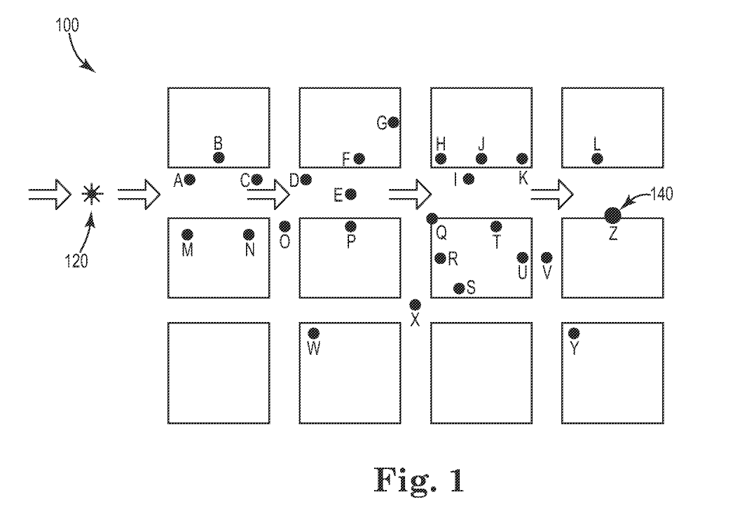

FIG. 1 provides an example illustration of a field of nodes 100 in an example area that resembles a set of blocks within a city. In this illustration, fixed nodes A-Z are dispersed throughout the field 100. Also shown in FIG. 1 is a mobile node 120, which intends to navigate a path through the field of nodes 100. More specifically, mobile node 120 intends to navigate through the city grid on a straight path through the field of nodes. As a non-limiting example, these fixed and mobile nodes may be any of a variety of devices, such as cellphones, smartphones, computers, tablets, navigation devices, cameras, or other electronic devices having sensory and processing capabilities.

In the example of FIG. 1, one particular node, node Z 140, is interested in the data about the navigational path and estimated arrival time of mobile node 120. This data concerning mobile node 120 is required because node Z 140 must perform some preparatory action, such as data processing, prior to the arrival or encounter with the mobile node 120. For example, node Z 140 may wish to perform some processing customized to the mobile node 120, and may not be able to fully complete the processing unless informed at least a few seconds or minutes ahead of the arrival of the mobile node 120.

One example field of use for tracking information related to a mobile node is targeted advertising that is intends to induce the mobile node into some responsive action. For example, assume that node Z 140 is a business that wishes to display targeted advertising customized to the mobile node 120, and encourage a person associated with the mobile node 120 to make a purchase, visit a business, etc. Therefore, the location information and the estimated time of arrival would be useful to determine when the mobile node 120 (and therefore the human user associated with the node) will be in proximity to advertisements or to node's location itself.

Processing may need to be performed ahead of time on the fixed node for a variety of real-world scenarios. Customized advertisements may need to be displayed to the mobile node ahead of the mobile node's navigation through some area; time-intensive credit checks may need seconds or minutes to complete before a financial transaction can be conducted; or processing resources may need to be freed up on the fixed node in order to properly communicate with a new mobile node or a certain type of mobile node. A wide variety of customized actions may need time for preparation.

As another use for the mobile node's tracking data, as the mobile node moves closer and closer to the fixed node, the fixed node may determine that there is a higher potential of the mobile node performing a certain activity (such as entering a business location or purchasing a product or service). Likewise, customized behavior might be performed by the fixed node or its agent, to provide a service to or response the mobile node and one or more human persons associated with the mobile node. Reminders or other messages may be sent to the mobile node in an attempt to have the mobile node switch its course of direction and visit the fixed node's location.

As part of the preparatory processing, the fixed node may identify if the mobile node is associated with a known customer or human. Thus, presume that the mobile node is a shopping cart accompanied by a human customer navigating through a supermarket or mass-market retailer. A fixed node located at the checkout area may offer various incentives to the customer relevant to the customer's selected products when the customer arrives. The processing to fully offer these incentives may require a measurable amount of preparation time and may not be conducted fast enough after the mobile node already reaches the fixed node.

If a customer is identified, a message such as a promotional offer, advertisement, or informational communication may be sent or displayed to the mobile node in order to encourage the human user to purchase of a product or service. In this way, targeted contact may be initiated with the mobile node in response to the node's movement in order to induce some behavior. This behavior is not limited to human responses that are unrelated to the mobile node's movement; but rather the behavior may include navigation-related actions such as inducing the mobile node to stop or change direction of its navigation. (Such as informing the mobile node to visit another portion of the store to obtain faster service).

As is evident, a wide variety of preparatory processing and actions might be performed as a result of learning and processing the location and path of a mobile node. For example, advertising may be customized based on the type of mobile nodes that are entering an area, or the advertising might change based upon when a set of new mobile nodes will arrive. Or, reminders and other information notifications can be provided to the mobile nodes based on the movement and proximity of the mobile node. A nearly limitless number of actions may be performed with the access to movement data of mobile nodes using the techniques described herein.

As previously suggested, tracking the movement of the mobile node may be performed through collaboration within the field of nodes. In one embodiment, the field of nodes operates to send movement and location information about the mobile node to other fixed nodes using peer-to-peer techniques. Information may be exchanged from one node to another using any number of technologies, including wired and wireless transmission mediums. This information may be propagated, relayed, and indirectly communicated throughout the network until it reaches the appropriate fixed node interested in the information.

Therefore, the presently disclosed techniques enable more than merely predicting an estimated time of arrival (ETA) of a mobile node using more than one sensor. Rather, these techniques enable use of an entire field of fixed nodes to sense, communicate, prepare, and respond to the mobile node's movement and actions. This information may be passed among the members of the field of nodes even if some of the fixed nodes cannot fully process the data or are not concerned with the data.

In one embodiment, a fixed node which detects the mobile node reports the mobile node's position and the time of sighting to its neighbors in the field of nodes, who in turn relay the mobile node's position and sighting time to their neighbors. In this way, the larger field of nodes becomes aware of the mobile node's progress through the field. As the mobile node passes through a fixed node's locale, the node detects the presence of the mobile node through one of a number of locating mechanisms known to the art or simply through communicating with the mobile node as it passes through the fixed nodes' very local network.

Additionally, the mobile node may itself choose to announce its position and time at regular intervals and take advantage of the neighborhood relay mechanism to publish the mobile node's movement throughout the field. If there is network connectivity that spans the field of fixed node, then this technique is particularly useful.

At any point in the mobile node's trip through the field of fixed nodes, the mobile node can announce its intended path to the field of nodes using the communications means described above. The path descriptor can be as simple as beginning and end points or a collection of path segments. If the field of nodes is aware of the mobile node's path, then an individual fixed node's incoming mobile queue is likely to be more accurate.

This knowledge of the movement of the mobile node through the field of fixed nodes allows any of the nodes to make a determination that the mobile node may come within its locale, and the estimated time of its arrival, thereby enabling the fixed node to perform some preprocessing or data access to facilitate useful work during the potentially brief period of time that the mobile node is in the vicinity of the fixed node.

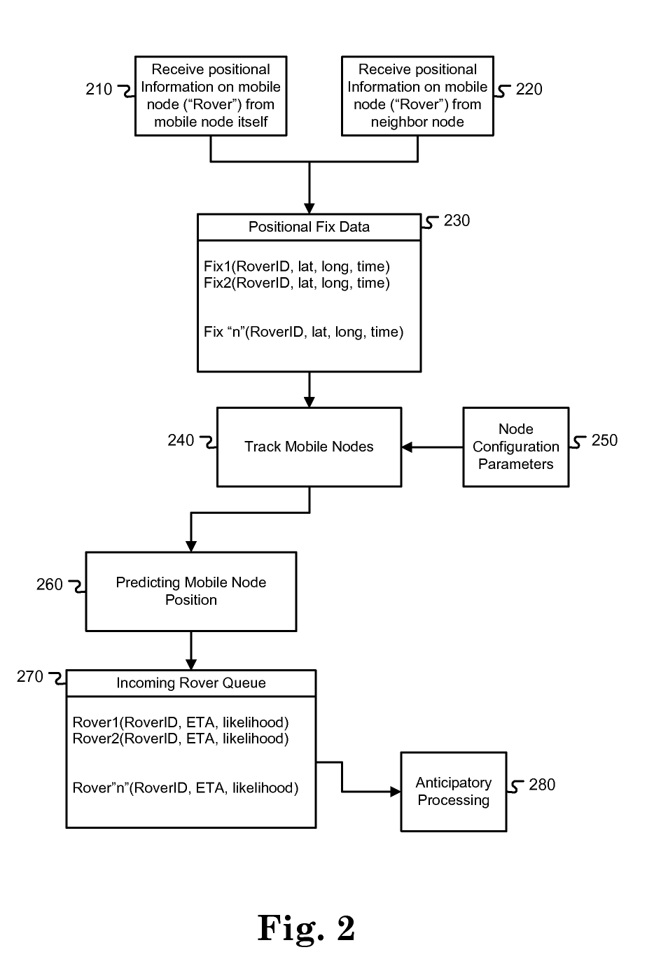

FIG. 2 provides a flowchart with an illustration of the various data processing actions used by fixed nodes for tracking and predicting the path of a mobile node according to one embodiment of the present invention. This flowchart more specifically demonstrates how a single fixed node in a field of nodes might process the movement of a mobile node. As shown, two sets of information may be received regarding the position/location of the mobile node. This may include positional information received from the mobile node itself as in 210, or it may include positional information received from one or more neighbor nodes in the field of nodes as in 220.

In either case (or with a combination of the positional data), the data is combined to produce a list of positional data from each “fix” or observation of the mobile node. This positional data can be compared, aggregated, and queued as in 230 in order to produce the most accurate view of a mobile node's true position. Further, this positional data may be collected for a plurality of mobile nodes. The positional data collected may include an identifier of the mobile node, the latitude or longitude coordinates of the node, the time the node provided the data or was proximate to the fixed node, and other positioning information.

Based on the set of positional fix data 230, the fixed node may track the mobile nodes as in 240 according to node configuration parameters 250. These parameters may specify which mobile nodes are tracked, which techniques are used to track the nodes, whether any nodes are ignored or monitored closely, and other parameters relevant to tracking. Next, the position of a specific mobile node is predicted as in 260 and provided as data into an incoming rover queue 270. This queue compiles a set of data indicating where each known mobile node is respective to the fixed node. For example, as shown in FIG. 2, the location of each rover may be identified by a mobile node ID, an estimated time of arrival or proximity to the fixed node, and the likelihood that the mobile node's current path will result in an encounter with the fixed node. Finally, based on the information of each incoming mobile node into the fixed node's proximity, a set of anticipatory processing functions 280 may be performed.

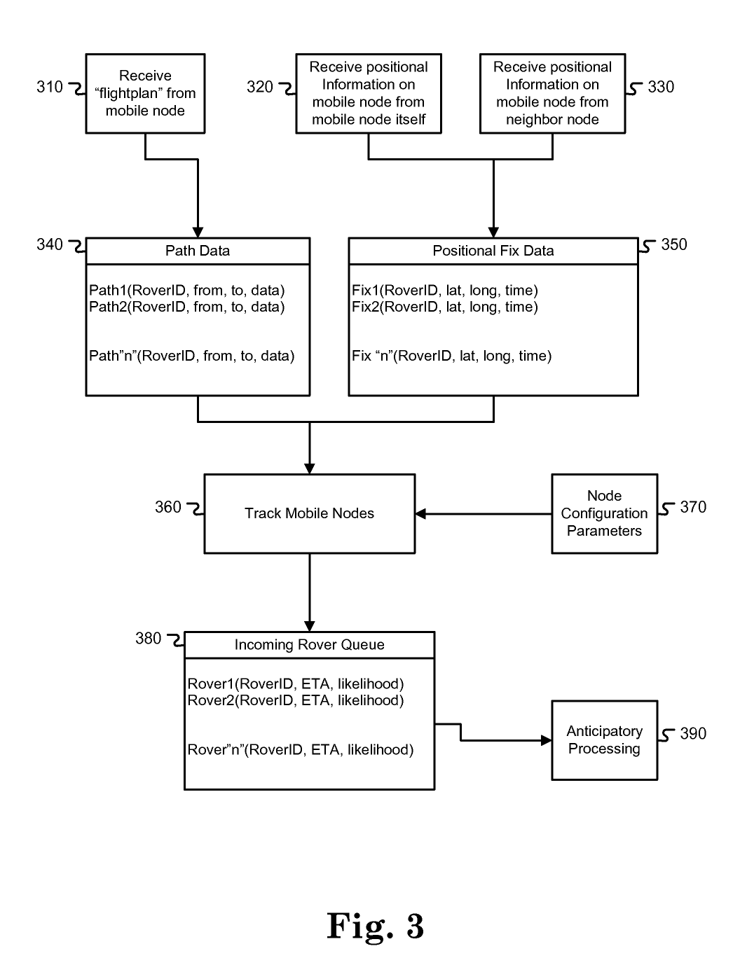

FIG. 3 provides a flowchart with an illustration of alternate techniques for tracking a mobile node on a defined path according to one embodiment of the present invention. Similar to FIG. 2, this flowchart provides a mechanism for tracking the movement of a plurality of mobile nodes. In FIG. 3, however, the path of the mobile node is generally known ahead of the mobile node's navigation, and is received as part of a navigational plan (a “flight plan”) from the mobile node as in 310. Therefore, the focus of this technique is not necessarily to predict the path of the moving node, but instead to track and verify the moving node's success on navigating its path.

To verify the mobile node's success in navigation, the actual position/location of the mobile node is collected. Again, this may be positional information received from the mobile node itself as in 320, or it may be positional information received from one or more neighbor nodes in the field of nodes as in 330. The positional fix data on the mobile node is collected in a queue as in 350. Likewise, the path data received from or provided by the mobile nodes is collected in a queue as in 340. This path data may contain basic or detailed information on the mobile node's projected path, allowing the compilation of an identifier of the mobile node, “from” and “to” positions on the data path, and any other data from the mobile node relevant to the projected path.

The path data information 340 and positional fix data 350 can then be compared and/or combined for use in tracking the mobile nodes as in 360. Similar to the techniques described for FIG. 2, node configuration parameters 370 may be used and factored for tracking the mobile nodes; a queue of mobile node movements may be prepared as in 380; and anticipatory processing as a result of tracking the mobile node can be executed in response to verification of the mobile node positions as in 390.

As evident from the preceding description, the presently disclosed techniques are distinguishable from existing methods that provide only a basic estimation of a mobile object's movement. As previously detailed, data from a plurality of fixed nodes in addition to data from the mobile node itself can be factored when tracking and verifying movement of the mobile node. Therefore, a higher degree of accuracy for tracking movement and predicting the ETA of the mobile node may be accomplished with the presently disclosed techniques.

Further, the presently disclosed techniques enable use of fixed nodes that are heterogeneous—these techniques may be applied to nodes of any type (single or multi purpose) that can detect and communicate positional information on a mobile node. The presently disclosed techniques may also use positional data captured from node field to predict ETA at a node, and use additional defined path data with data captured from node field to predict ETA.

Those of ordinary skill in the art would recognize that the presently disclosed techniques and systems may be used in conjunction with various types of smart communication networks. For example, Motes, Smartdust and Mesh Networks may provide an infrastructure for a node field that might be used in conjunction with the presently disclosed techniques. However, the presently disclosed techniques provide far more flexibility and capabilities rather than use of these networks alone, because the presently described embodiments do not require a base station to report back to—rather, the monitoring techniques may be completely peer to peer.

As will be appreciated by one of ordinary skill in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method of tracking a mobile node in a field of nodes, comprising:
receiving, at a selected node, positional data indicating a geographic location of the mobile node within the field of nodes, the positional data including location measurements conducted by other nodes in the field of nodes;
collecting historical positional data of the mobile node, the historical positional data including a plurality of geographical locations of the mobile node within the field of nodes over a period of time;
tracking a geographic path and movement characteristics of the mobile node in the field of nodes within the period of time based on the historical positional data;
predicting future geographic locations of the mobile node within a period of future time based on the geographic path and the movement characteristics of the mobile node; and
estimating a time of arrival and a likelihood of arrival of the mobile node to a defined proximity of the selected node, by factoring the future geographic locations of the mobile node within the period of future time.

2. The method of claim 1, further comprising:
performing anticipatory processing at the selected node prior to arrival of the mobile node to the defined proximity in response to the estimated time of arrival and the likelihood of arrival of the mobile node.

3. The method of claim 1, further comprising:
obtaining additional positional data indicating the geographic location of the mobile node by conducting location measurements with the selected node; and
communicating the additional positional data from the selected node to the other nodes in the field of nodes.

4. The method of claim 1, further comprising:
receiving a movement plan from the mobile node and computing the geographic path of the mobile node based on the movement plan;
wherein tracking the geographic path of the mobile node includes factoring the movement plan in addition to the positional data.

5. The method of claim 4, wherein the movement plan received from the mobile node contains movement data including a start location and a destination location for movement of the mobile node.

6. The method of claim 4, wherein tracking geographic path of the mobile node includes receiving updated positions responsive to movement of the mobile node.

7. The method of claim 1, wherein the positional data further includes location information provided by the mobile node.

8. The method of claim 1, wherein the positional data includes an identifier of the mobile node, latitude and longitude coordinates, and a time of positional measurement.

9. The method of claim 1, wherein the other nodes in the field of nodes relay positional information on the location of the mobile node to the selected node using cooperative peer-to-peer communications.

10. The method of claim 1, further comprising:
factoring a plurality of configuration parameters relevant to the mobile node when tracking the geographic path and movement characteristics of the mobile node.

11. A system, comprising:
a plurality of fixed nodes, the plurality of fixed nodes including a selected node;
a network facilitating communication between the plurality of fixed nodes;
one or more mobile nodes navigating through a field of nodes containing some or all of the plurality of fixed nodes;
processing instructions executed on hardware within the plurality of fixed nodes to track the one or more mobile nodes within the field of nodes containing some or all of the plurality of fixed nodes, the processing instructions configured for:
receiving, at the selected node, positional data indicating a geographic location of the one or more mobile nodes within the field of nodes, the positional data including location measurements conducted by other nodes in the field of nodes;
collecting historical positional data of the one or more mobile nodes, the historical positional data including a plurality of geographical locations of the one or more mobile nodes within the field of nodes over a period of time;
tracking a geographic path and movement characteristics of the one or more mobile nodes in the field of nodes within the period of time based on the historical positional data;
predicting future geographic locations of the one or more mobile nodes within a period of future time based on the geographic path and the movement characteristics of the one or more mobile nodes; and
estimating a time of arrival and a likelihood of arrival of the one or more mobile nodes to a defined proximity of the selected node, by factoring the future geographic locations of the one or more mobile nodes within the period of future time.

12. The system of claim 11, wherein the processing instructions are further configured for:
performing anticipatory processing at the selected node prior to arrival of the one or more mobile nodes to the defined proximity in response to the estimated time of arrival and the likelihood of arrival of the one or more mobile nodes.

13. The system of claim 11, wherein the processing instructions are further configured for:
obtaining additional positional data indicating the geographic location of the one or more mobile nodes by conducting location measurements with the selected node; and
communicating the additional positional data from the selected node to the other nodes in the field of nodes.

14. The system of claim 11, wherein the processing instructions are further configured for:
receiving a movement plan from the one or more mobile nodes and computing the geographic path of the one or more mobile nodes based on the movement plan;
wherein tracking the geographic path of the one or more mobile nodes includes factoring the movement plan in addition to the positional data.

15. The system of claim 14, wherein the movement plan received from the one or more mobile nodes contains movement data including a start location and a destination location for movement of the one or more mobile nodes.

16. The system of claim 14, wherein tracking geographic path of the one or more mobile nodes includes receiving updated positions responsive to movement of the one or more mobile nodes.

17. The system of claim 11, wherein the positional data further includes location information provided by the one or more mobile nodes.

18. The system of claim 11, wherein the positional data includes identifiers of the one or more mobile nodes, latitude and longitude coordinates, and a time of positional measurement.

19. The system of claim 11, wherein the other nodes in the field of nodes relay positional information on the location of the one or more mobile nodes to the selected node using cooperative peer-to-peer communications.

20. The system of claim 11, wherein the processing instructions are further configured for:
factoring a plurality of configuration parameters relevant to the one or more mobile nodes when tracking the geographic path and movement characteristics of the mobile node.
